(19) United States
(12) Patent Application Publication
(10) Pub. No.: US 2019/0320637 A1
(43) Pub. Date: Oct. 24, 2019

(54) Bag for Boat Livewell

(71) Applicant: Rig-Rite Manufacturing, Inc., Miltona, MN (US)

(72) Inventors: Stephen J. Klarich, Eagle Bend, MN (US); Lynn R. Kasma, New York Mills, MN (US)

(73) Assignee: Rig-Rite Manufacturing, Inc.

(21) Appl. No.: 15/955,888

(22) Filed: Apr. 18, 2018

(51) Int. Cl. A01K 97/20; B65D 30/06

(52) U.S. Cl. CPC A01K 97/20; B63B 2231/50; B65D 29/04

(57) ABSTRACT

A bag for boat livewell for providing efficient removal and transport of fish from a boat's live well. The bag for boat livewell generally includes a bag having a floor, an upper opening opposite of the floor, a first sidewall extending from the floor, a second sidewall extending from the floor, a first end wall extending between the first sidewall and the second sidewall, and a second end wall extending between the first sidewall and second sidewall. The bag is constructed of a water permeable material. A first handle and a second handle extend from the first sidewall and the second sidewall respectively. A first interior closure and a second interior closure are attached to the sidewalls for selective closing of the upper opening. A first buoyant member and a second buoyant member are attached to the first sidewall and the second sidewall respectively.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a bag for boat livewell for providing efficient removal and transport of fish from a boat's live well.

### Related Art

Any discussion of the related art throughout the specification should in no way be considered as an admission that such related art is widely known or forms part of common general knowledge in the field.

A livewell is a tank found on fishing boats used to keep bait and caught fish alive. The tank of the livewell has a cover to selectively enclose the upper opening the tank. A livewell works by pumping fresh water from the surrounding body of water (e.g. lake, river) into the livewell tank, as well as keeping the water aerated. Livewells have various shapes and sizes based on the boat, size of fish and other factors.

One of the problems of livewells is that it can be difficult to remove fish from the live well. To remove the fish from the livewell, the fisherman typically removes each fish individually. The fish removed may be inserted into a container such as a bag for weighing at a fishing tournament.

### SUMMARY

An example embodiment is directed to a bag for boat livewell. The bag for boat livewell includes a bag having a floor, an upper opening opposite of the floor, a first sidewall extending from the floor, a second sidewall extending from the floor, a first end wall extending between the first sidewall and the second sidewall, and a second end wall extending between the first sidewall and second sidewall. The bag is constructed of a water permeable material. A first handle and a second handle extend from the first sidewall and the second sidewall respectively. A first interior closure and a second interior closure are attached to the sidewalls for selective closing of the upper opening. A first buoyant member and a second buoyant member are attached to the first sidewall and the second sidewall respectively.

There has thus been outlined, rather broadly, some of the embodiments of the bag for boat livewell in order that the detailed description thereof may be better understood, and in order that the present contribution to the art may be better appreciated. There are additional embodiments of the bag for boat livewell that will be described hereinafter and that will form the subject matter of the claims appended hereto. In this respect, before explaining at least one embodiment of the bag for boat livewell in detail, it is to be understood that the bag for boat livewell is not limited in its application to the details of construction or to the arrangements of the components set forth in the following description or illustrated in the drawings. The bag for boat livewell is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a bag for boat livewell in an open state in accordance with an example embodiment.

FIG. 2 is a perspective view of a bag for boat livewell in a closed state in accordance with an example embodiment.

FIG. 3a is an end view of a bag for boat livewell in an open state in accordance with an example embodiment.

FIG. 3b is a side view of a bag for boat livewell in accordance with an example embodiment.

FIG. 4 is a top view of a bag for boat livewell in an open state in accordance with an example embodiment.

FIG. 5 is a bottom view of a bag for boat livewell in accordance with an example embodiment.

FIG. 6 is a cross sectional view taken along line 6-6 of FIG. 4 with the bag in the open state.

FIG. 7 is a cross sectional view taken along line 6-6 of FIG. 4 with the bag in the closed state.

FIG. 8 is a top view of a bag for boat livewell positioned within a boat's livewell and positioned in an open state in accordance with an example embodiment.

FIG. 9 is a cross sectional view taken alone line 9-9 of FIG. 8.

FIG. 10 is a top view of a bag for boat livewell positioned within a boat's livewell and positioned in an open state in accordance with another example embodiment.

FIG. 11 is a cross sectional view taken alone line 11-11 of FIG. 10.

FIG. 12 is a top view of a bag for boat livewell positioned within a boat's livewell and positioned in an open state in accordance with another example embodiment.

FIG. 13 is a cross sectional view taken alone line 13-13 of FIG. 12.

FIG. 14 is a top view of a bag for boat livewell positioned within a boat's livewell and positioned in an open state in accordance with another example embodiment.

FIG. 15 is a cross sectional view taken alone line 15-15 of FIG. 14.

FIG. 16 is an end cutaway view of a bag for boat livewell in accordance with another example embodiment.

### DETAILED DESCRIPTION

### A. Overview.

An example bag for boat livewell generally comprises a bag 20 having a floor 22, an upper opening 21 opposite of the floor 22, a first sidewall 24 extending from the floor 22, a second sidewall 26 extending from the floor 22, a first end wall 28 extending between the first sidewall 24 and the second sidewall 26, and a second end wall 29 extending between the first sidewall 24 and second sidewall 26. The bag 20 is constructed of a water permeable material. A first handle 32 and a second handle 34 extend from the first sidewall 24 and the second sidewall 26 respectively. A first interior closure 40 and a second interior closure 42 are attached to the sidewalls for selective closing of the upper opening 21. A first buoyant member 50 and a second buoyant member 52 are attached to the first sidewall 24 and the second sidewall 26 respectively.

### B. Permeable Bag.

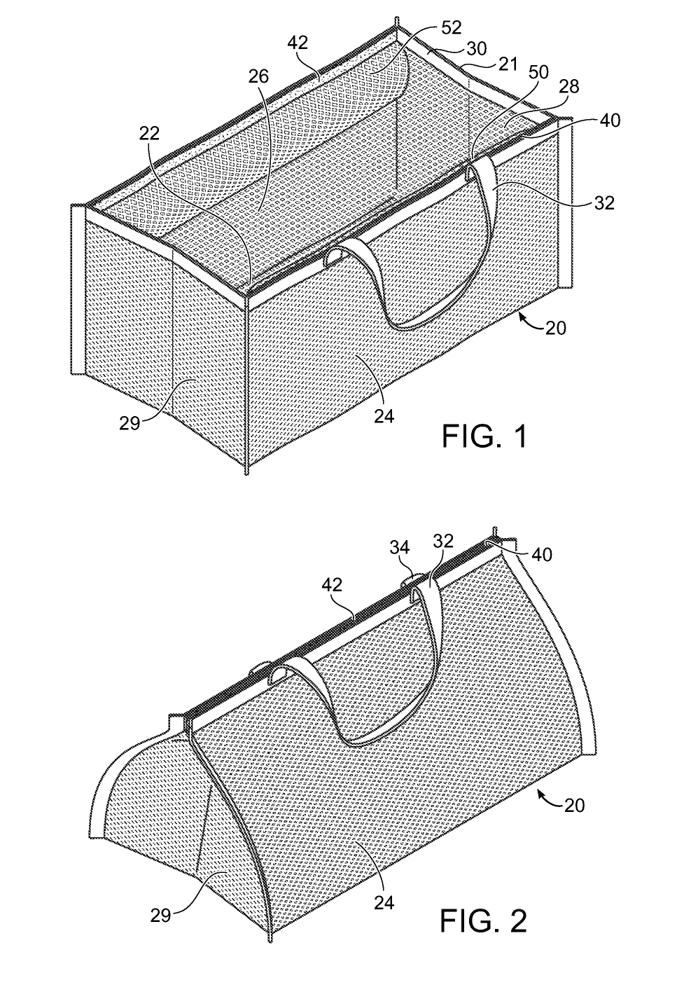

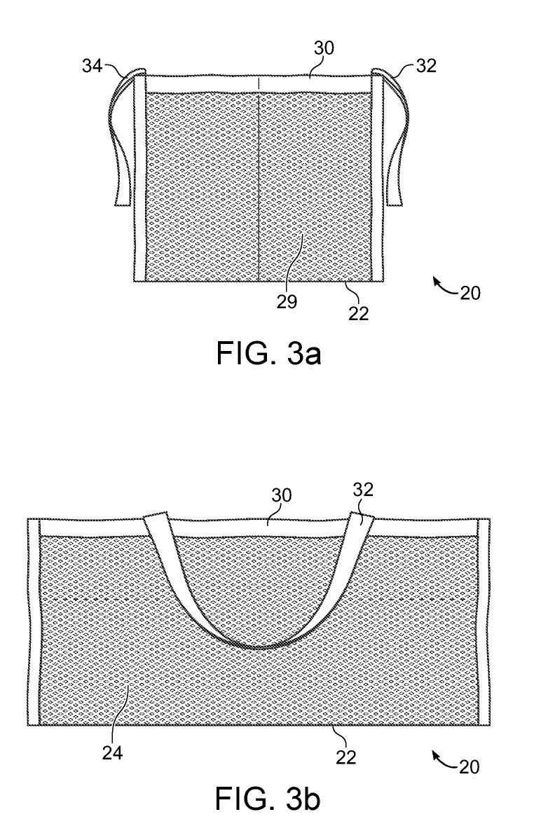

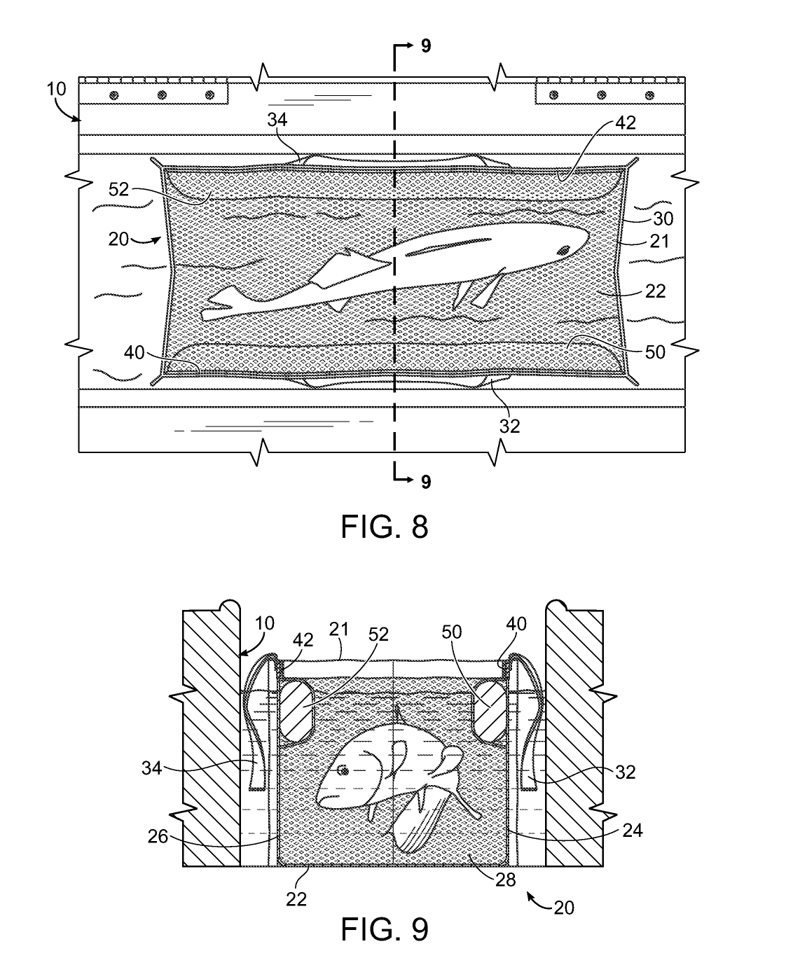

FIGS. 1 through 16 illustrate various embodiments that include a bag 20 that is constructed of a water permeable material (e.g. mesh material). The bag 20 is adapted for receiving and storing one or more fish as illustrated in FIGS. 8 through 15. The bag 20 is further adapted to be removably positioned within a livewell 10 of a boat as further shown in FIGS. 8 through 15 of the drawings. The bag 20 may have various shapes (e.g. circular, square, rectangular).

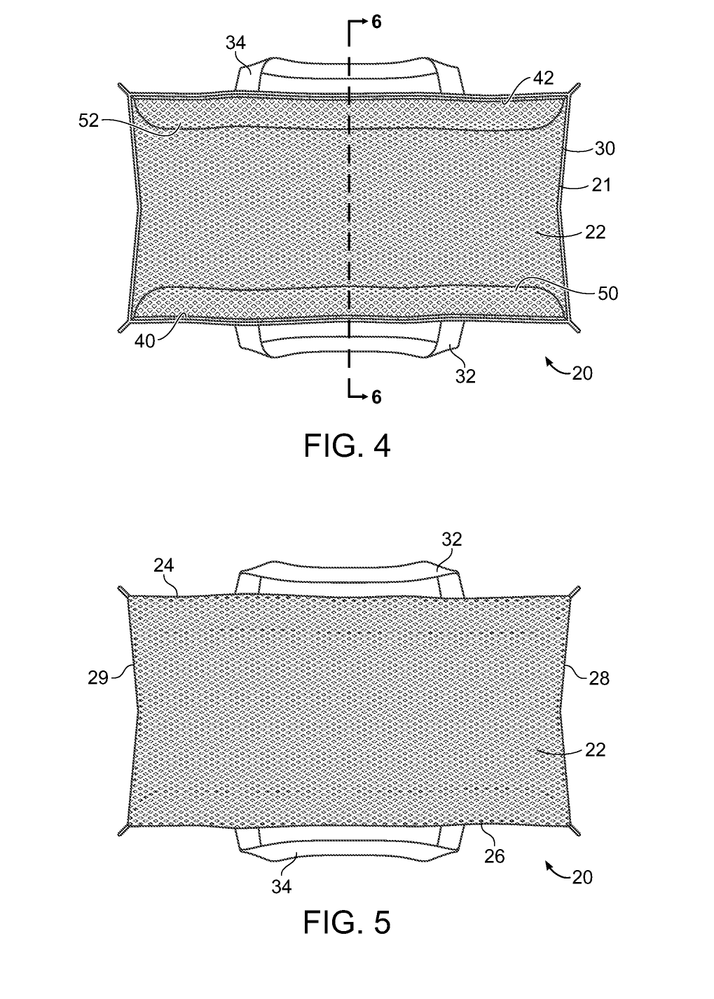

In one example embodiment shown in FIGS. 1 through 3b of the drawings, the bag 20 includes a floor 22, an upper opening 21 opposite of the floor 22, a first sidewall 24 extending from the floor 22, a second sidewall 26 extending from the floor 22, a first end wall 28 extending between the first sidewall 24 and the second sidewall 26, and a second end wall 29 extending between the first sidewall 24 and second sidewall 26. In another embodiment, the upper opening 21 is rectangular shaped when in the open state as shown in FIGS. 1 and 4 of the drawings. The floor 22, the first sidewall 24, the second sidewall 26, the first end wall 28 and the second end wall 29 each are preferably rectangular shaped as shown in FIGS. 1 through 3b of the drawings. However, various other shapes and structures may be used other than illustrated in the figures.

In one example embodiment, the upper opening 21 has a length of approximately 24 inches and a width of approximately 11 inches. In another embodiment, the sidewalls 24, 26 and end walls 28, 29 have a height of approximately 12 inches. Various other lengths, widths and heights may be used with the various embodiments.

The bag 20 is constructed of a material that is permeable to water. It is preferable that the bag 20 is constructed of a material with a plurality of holes. For example, the bag 20 is preferably comprised of a mesh material in one embodiment. The mesh material is preferably flexible and constructed of a flexible material such as, but not limited to, a plastic mesh material. The mesh material may be vinyl coated or constructed of vinyl. The bag 20 is preferably UV resistant, tear resistant, rot resistant and mildew resistant to withstand the environment encountered by fishermen.

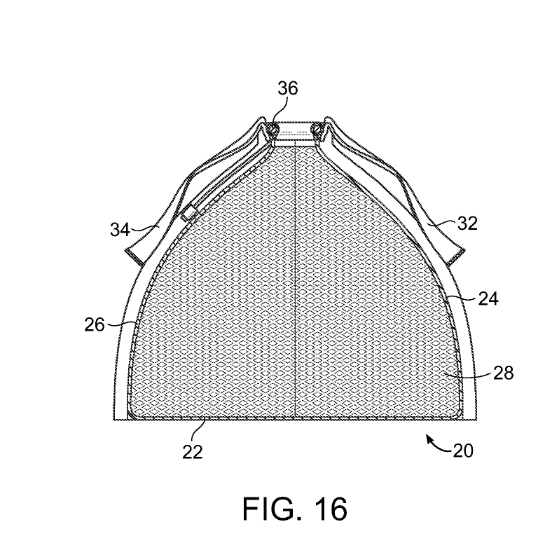

The bag 20 preferably includes boning 30 attached around an upper perimeter of the bag 20 adjacent the upper opening 21 as shown in FIGS. 1 and 2 of the drawings. The boning 30 strengthens the upper opening 21 to keep the upper opening 21 relatively rigid during usage. In another embodiment shown in FIG. 16, a drawstring 36 may extend through a channel within the upper perimeter of the bag 20 to allow a user to selectively close the upper opening 21 by drawing together the drawstring 36.

### C. Handles.

A first handle 32 attached to the first sidewall 24 and a second handle 34 attached to the second sidewall 26 as shown in FIGS. 1 through 3a of the drawings. The first handle 32 and the second handle 34 are each preferably comprised of a looped structure adapted for extending upwardly above the upper opening 21 of the bag 20. The first handle 32 and the second handle 34 are further preferably attached to an upper portion of the bag 20. The first handle 32 and the second handle 34 are further preferably flexible in accordance with another embodiment.

### D. Buoyant Members.

A first buoyant member 50 is attached to an upper portion of the first sidewall 24 and a second buoyant member 52 attached to an upper portion of the second sidewall 26 to vertically support the upper portion of the bag 20 when positioned within water in the livewell 10 in accordance with an example embodiment illustrated in FIGS. 1 through 9 of the drawings. In an embodiment, the sidewalls 24, 26 are wrapped around the buoyant members 50, 52 respectively to secure the buoyant members 50, 52 to the bag 20. The buoyant members 50, 52 preferably provide sufficient buoyancy to keep the upper opening 21 of the bag 20 near the upper surface of the water in the livewell 10.

The first buoyant member 50 and the second buoyant member 52 are each comprised of a water buoyant material such as a foam material (e.g. extruded polystyrene foam). FIGS. 1 and 4 illustrate the buoyant members 50, 52 having an elongated and oblong structure, though various other structures may be used to provide buoyancy to support the bag 20 when positioned within water in the livewell 10.

The first buoyant member 50 extends along a substantial length of the first sidewall 24 and is positioned near the upper opening 21 in an example embodiment shown in FIGS. 1, 4, 6 and 9 of the drawings. The second buoyant member 52 extends along a substantial length of the second sidewall 26 and is positioned near the upper opening 21 in an example embodiment shown in FIGS. 1, 4, 6 and 9 of the drawings.

### E. Interior Closures.

A first interior closure 40 is attached to an interior of the first sidewall 24 and a second interior closure 42 is attached to an interior of the second sidewall 26 as shown in FIGS. 1, 2, 4, 6 and 7 of the drawings. The first interior closure 40 and the second interior closures 42 are adapted for removably connecting to one another to selectively close the upper opening 21 of the bag 20 as illustrated in FIG. 7. When the upper opening 21 of the bag 20 is in the open state, the first interior closure 40 and the second interior closure 42 are preferably not attached to one another.

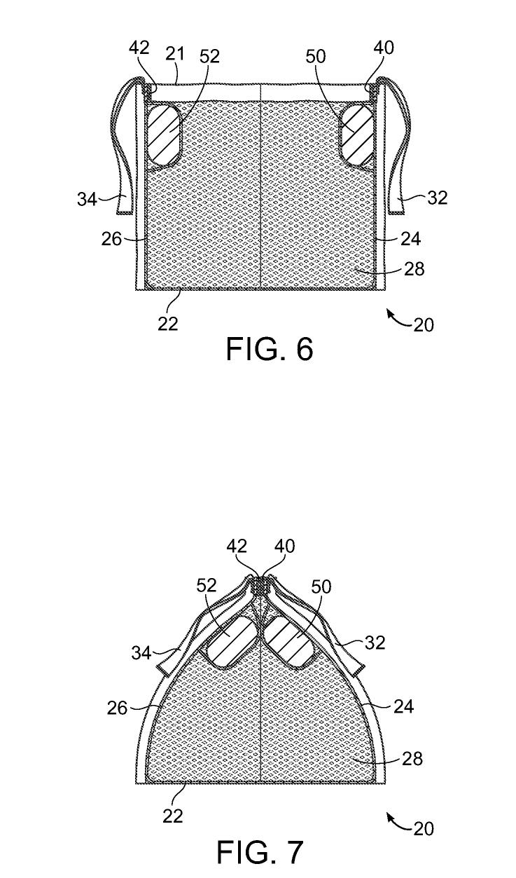

The first interior closure 40 and the second interior closure 42 are preferably positioned above the buoyant members 50, 52 respectively as illustrated in FIG. 6 of the drawings. However, the first interior closure 40 and the second interior closure 42 may be positioned to the side of or below the buoyant members 50, 52.

The first interior closure 40 and the second interior closure 42 are comprised of hook and loop fastener in an example embodiment. However, the interior closures 40, 42 may be comprised of other closures such as snaps and hooks to close the upper opening 21.

The first interior closure 40 extends along a substantial length of the first sidewall 24 adjacent to the upper opening 21 and the second interior closure 42 extends along a substantial length of the second sidewall 26 adjacent to the upper opening 21 in an example embodiment best illustrated in FIG. 4 of the drawings. It can be appreciated that the interior closures 40, 42 are not required to extend along the entire length of the sidewalls 24, 26 and instead may be intermittent or extend only partially along the length of the sidewalls.

### F. Exterior Connectors.

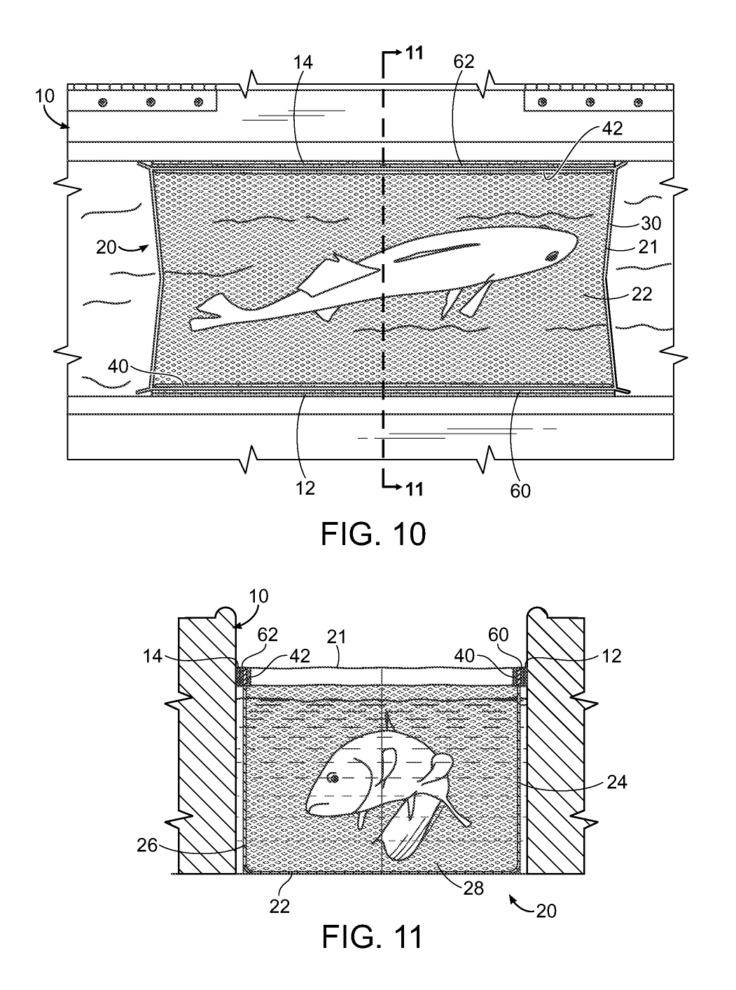

In another embodiment, a first connector 60 is attached to the exterior of the first sidewall 24 and is adapted to removably connect to a first wall connector 12 of the livewell 10 as illustrated in FIGS. 10 through 15 of the drawings. A second connector 62 is attached to the exterior of the second sidewall 26 and is adapted to removably connect to a second wall connector 14 of the livewell 10 as further illustrated in FIGS. 10 through 15 of the drawings. The first connector 60 and the second connector 62 may be used alternatively to or in combination with the buoyant members 50, 52 to maintain the upper opening 21 in an open state and near the upper surface of the water in the livewell 10.

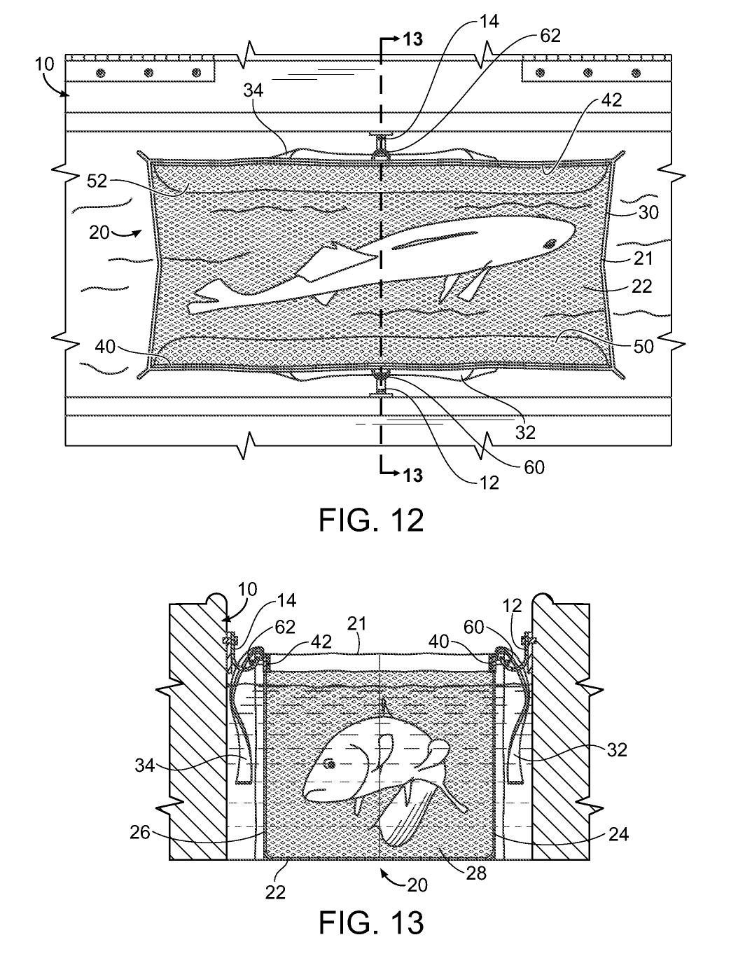

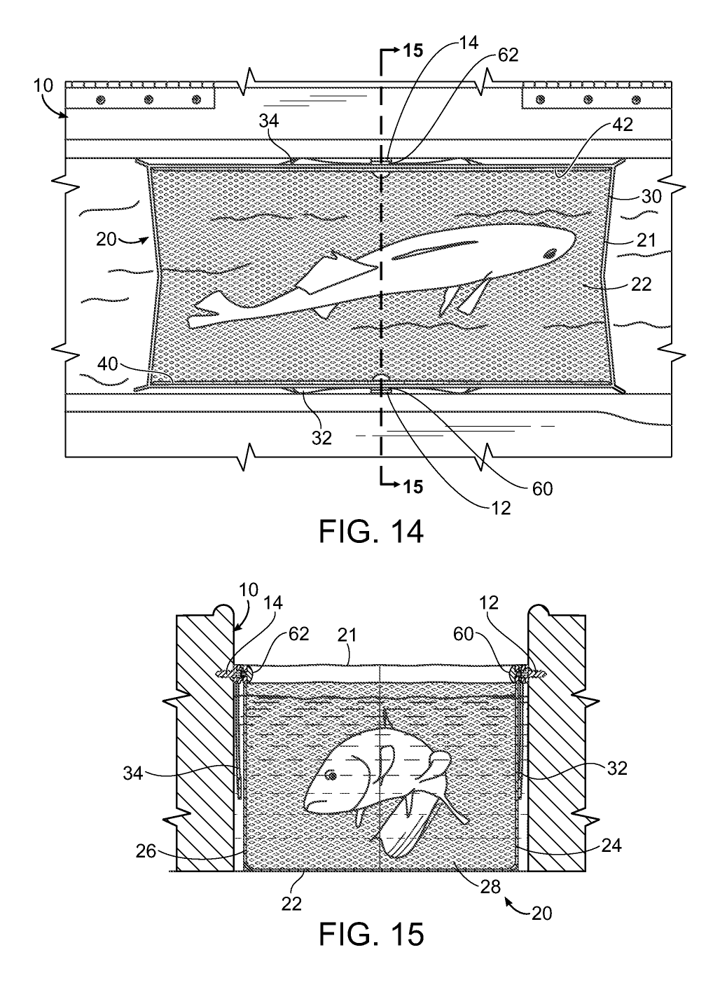

In one embodiment, the first connector 60, the second connector 62, the first wall connector 12 and the second wall connector 14 are each comprised of a snap connector as shown in FIGS. 14 and 15 of the drawings. In another embodiment, the first connector 60, the second connector 62, the first wall connector 12 and the second wall connector 14 are each comprised of hook and loop fastener as shown in FIGS. 10 and 11 of the drawings. In another embodiment, the first connector 60, the second connector 62, the first wall connector 12 and the second wall connector 14 are each comprised of a J-hook and loop connector structure as shown in FIGS. 12 and 13 of the drawings. Various other connectors may be used for the first connector 60, the second connector 62, the first wall connector 12 and the second wall connector 14.

### G. Operation of Preferred Embodiment.

In use, user positions the bag 20 within the interior of the boat's livewell 10 as shown in FIGS. 8 through 15 of the drawings. The buoyant members 50, 52 or connectors 60, 62 retain the upper portion of the bag 20 near the upper surface of the water in the life well which makes it easy for the user to insert fish into the bag 20 and to prevent the fish from escaping the bag 20. The buoyant members 50, 52 result in the bag 20 being a free floating structure within the water of the livewell 10. When the fisherman desires to remove the fish, the fisherman closes the bag 20 by connecting the interior closures 40, 42 together thereby preventing the escape of the fish. If the fisherman wants ice to be used within the bag 20 to chill the fish, the ice is positioned within the bag 20 with the fish with or without water in the livewell 10. The fisherman may transport the fish in the bag 20 to various locations once removed from the livewell 10. The upper opening 21 may be opened and the fish removed for cleaning or release at a desired location.

Unless otherwise defined, all technical and scientific terms used herein have the same meaning as commonly understood by one of ordinary skill in the art to which this invention belongs. Although methods and materials similar to or equivalent to those described herein can be used in the practice or testing of the bag for boat livewell, suitable methods and materials are described above. All publications, patent applications, patents, and other references mentioned herein are incorporated by reference in their entirety to the extent allowed by applicable law and regulations. The bag for boat livewell may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A bag for a livewell, comprising:
a bag adapted for receiving and storing fish, wherein the bag is adapted to be removably positioned within a livewell of a boat;
wherein the bag includes a floor, an upper opening opposite of the floor, a first sidewall extending from the floor and a second sidewall extending from the floor;
wherein the bag is constructed of a mesh material, wherein the mesh material is flexible.

2. The bag for a livewell of claim 1, including a first end wall extending between the first sidewall and the second sidewall, and a second end wall extending between the first sidewall and the second sidewall.

3. The bag for a livewell of claim 2, wherein the upper opening is rectangular shaped.

4. The bag for a livewell of claim 3, wherein the first sidewall, the second sidewall, the first end wall and the second end wall each are rectangular shaped.

5. The bag for a livewell of claim 4, wherein the floor is rectangular shaped.

6. The bag for a livewell of claim 1, wherein the mesh material is a plastic mesh material.

7. The bag for a livewell of claim 1, wherein the mesh material is vinyl coated mesh.

8. The bag for a livewell of claim 1, including boning attached around an upper perimeter of the bag adjacent the upper opening.

9. The bag for a livewell of claim 1, including a first handle attached to the first sidewall and a second handle attached to the second sidewall.

10. The bag for a livewell of claim 9, wherein the first handle and the second handle are each comprised of a looped structure adapted for extending upwardly above the upper opening of the bag.

11. The bag for a livewell of claim 1, including a first interior closure attached to an interior of the first sidewall and a second interior closure attached to an interior of the second sidewall, wherein the first interior closure and the second interior closure are adapted for removably connecting to one another to selectively close the upper opening of the bag.

12. The bag for a livewell of claim 11, wherein the first interior closure and the second interior closure are comprised of hook and loop fastener.

13. The bag for a livewell of claim 12, wherein the first interior closure extends along a substantial length of the first sidewall adjacent to the upper opening and wherein the second interior closure extends along a substantial length of the second sidewall adjacent to the upper opening.

14. The bag for a livewell of claim 1, including a first buoyant member attached to an upper portion of the first sidewall and a second buoyant member attached to an upper portion of the second sidewall.

15. The bag for a livewell of claim 14, wherein the first buoyant member and the second buoyant member are each comprised of a foam material.

16. The bag for a livewell of claim 14, wherein the first buoyant member extends along a substantial length of the first sidewall and is positioned near the upper opening, and wherein the second buoyant member extends along a substantial length of the second sidewall and is positioned near the upper opening.

17. The bag for a livewell of claim 16, including a first interior closure attached to an interior of the first sidewall above the first buoyant member and a second interior closure attached to an interior of the second sidewall above the second buoyant member, wherein the first interior closure and the second interior closure are adapted for removably connecting to one another to selectively close the upper opening of the bag.

18. The bag for a livewell of claim 1, including a first connector adapted to removably connect to a first wall connector of the livewell, and a second connector adapted to removably connect to a second wall connector of the livewell.

19. The bag for a livewell of claim 18, wherein the first connector and the second connector are comprised of a snap connector.

20. A bag for a livewell, comprising:
a bag adapted for receiving and storing fish, wherein the bag is adapted to be removably positioned within a livewell of a boat;
wherein the bag includes a floor, an upper opening opposite of the floor, a first sidewall extending from the floor, a second sidewall extending from the floor, a first end wall extending between the first sidewall and the second sidewall, and a second end wall extending between the first sidewall and second sidewall;
wherein the bag is constructed of a mesh material, wherein the mesh material is flexible, and wherein the mesh material is a plastic mesh material;
the upper opening is rectangular shaped;
wherein the floor, the first sidewall, the second sidewall, the first end wall and the second end wall each are rectangular shaped;
a first handle attached to the first sidewall and a second handle attached to the second sidewall;
a first interior closure attached to an interior of the first sidewall and a second interior closure attached to an interior of the second sidewall, wherein the first interior closure and the second interior closure are adapted for removably connecting to one another to selectively close the upper opening of the bag;
wherein the first interior closure and the second interior closure are comprised of hook and loop fastener; and
a first buoyant member attached to an upper portion of the first sidewall above the first buoyant member and a second buoyant member attached to an upper portion of the second sidewall above the second buoyant member.
